(19) United States
(12) Patent Application Publication
(10) Pub. No.: US 2006/0277250 A1
(43) Pub. Date: Dec. 7, 2006

(54) Methods and systems for checking accessibility of web applications

(76) Inventors: Sebastien Cherry, Brossard (CA); Michel Martin, Laval (CA)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/143,650

(22) Filed: Jun. 3, 2005

(51) Int. Cl. G06F 15/16

(52) U.S. Cl. 709/203

(57) ABSTRACT

Methods and systems for checking the accessibility of a web application may include a proxy adapted to intercept HTTP requests sent by a web browser to an application server. The proxy may further be adapted to intercept HTTP responses returned from the application to the browser. The HTTP responses may be parsed and analyzed for violations of an accessibility rule. A user checking the accessibility of a web application may be notified of any identified violation of the accessibility rule.

### TECHNICAL FIELD

This invention relates generally to network-based transactional applications, and more specifically to methods and systems for testing the accessibility of information contained in network-based transactional applications.

### BACKGROUND

Over the last several years, a revolution has occurred in the manner in which information is spread. Network applications are becoming increasingly vital in the everyday activities of almost every person—whether in the educational, business or personal aspects of their lives. As society becomes more dependent on networks, such as the Internet, to send and receive information, it is important that network applications be accessible to all users, including and especially those with disabilities.

In the world of electronic and information technology, accessibility refers to the possibility for users, regardless of disability, to access and use technology and information products. A piece of software or a web site, for instance, is accessible if it can be accessed by people with any of the following types of disabilities: (i) sensory impairments (i.e. vision or hearing); (ii) mobility impairments; or (iii) cognitive impairments. For information accessibility purposes, a disability can include both physical or mental impairments personal to the user, or environmentally-imposed disabilities such as a noisy factory floor or a poorly lit room. Accordingly, accessible products can be used eyes-free, ears-free or hands-free. Software companies are increasingly focusing on accessibility issues, for legal reasons, to remain competitive in the industry as well as for reasons of social responsibility.

In order to address the issue of information accessibility, software industry organizations have been created to formulate guidelines and standards for evaluating a website's or application's accessibility. Examples of these guidelines include: (i) providing a text description of audiovisual clips to allow those with auditory impairment to understand what is being said; (ii) providing structural content with uniform headings and fonts to allow users to more easily recognize changes in the scope and type of information; and (iii) allowing a user to enter information in multiple ways, such as using a point-and-click device, voice recognition software or a keyboard. More information on standardized accessibility guidelines is available in the Web Content Accessibility Guidelines, drafted by the World Wide Web Consortium (W3C).

While these guidelines are useful in educating software developers regarding the issues involved in accessibility, it is difficult for a design manager to determine whether a software application meets all of the recommended criteria. Even by performing a comprehensive self-evaluation, it may be difficult for a designer to ascertain compatibility with all accessibility needs, particularly when the person making the evaluation is not subject to the disabilities that create the need for enhanced accessibility.

Several tools have been developed to assist in evaluating the accessibility deficits of websites. However, the services available assist mainly in evaluating static HTML files or websites. They are not capable of navigating a website or application that requires transactional content to be input by the user, such as a login name and password. Further, it is awkward to use these tools in the development of applications, particularly as it may constitute a disclosure of proprietary information that may impair the designer's potential patent or trade secret rights.

### SUMMARY

An accessibility checker, implemented with a processor, tests accessibility compliance of transactional network applications. More particularly, the accessibility checker tests the accessibility of an HTTP response sent from an application server to a web browser and comprises a proxy and a parser. The proxy may be adapted to receive an HTTP request from the web browser and to forward the HTTP request to the application server. The proxy may further be adapted to receive the HTTP response from the application server. The parser may be adapted to receive a copy of the HTTP response from the proxy thread, wherein the parser may parse the HTTP response and analyze it for a violation of an accessibility rule. The accessibility checker may further comprise an interface adapted to notify a user of an identified violation received from the parser.

A method performed by a processor checks the accessibility of an HTTP response sent from an application server to a web browser. The method includes: (i) intercepting an HTTP request sent from the web browser and forwarding the HTTP request to the application server; (ii) intercepting the HTTP response from the application server; (iii) parsing and analyzing the HTTP response for a violation of an accessibility rule; and (iv) returning an identified violation of the accessibility rule to a user.

A computer-readable medium contains instructions, the execution of which causes a computer to perform a method for checking the accessibility of an HTTP response sent from an application server to a web browser. The method includes: (i) intercepting a file sent from an application server to a web browser; (ii) parsing the file and analyzing it for a violation of an accessibility rule; and (iii) notifying the user of an identified violation of the accessibility rule.

It is to be understood that both the foregoing general description and the following detailed description are exemplary and explanatory only and are not restrictive of the invention as claimed. The foregoing background and summary are not intended to provide any independent limitations on the claimed invention.

### BRIEF DESCRIPTION OF THE DRAWINGS

The accompanying drawings, which are incorporated in and constitute a part of this specification, illustrate several embodiments of the invention and together with the description, serve to explain the principles of the invention. In the drawings:

FIG. 1 is an exemplary view of a transactional application that may be tested with an accessibility checker consistent with an embodiment of the present invention.

FIG. 2 is a flow diagram illustrating the operation of an accessibility checker consistent with an embodiment of the present invention.

FIG. 3 is an exemplary structure of a violation report generated by an accessibility checker consistent with an embodiment of the present invention with the contextual menu open.

FIG. 4 is an exemplary structure of a violation report generated by an accessibility checker consistent with an embodiment of the present invention with a source code viewing window open.

FIG. 5 is an exemplary transactional application server page that may be tested with an accessibility checker consistent with an embodiment of the present invention.

FIG. 6 is an exemplary structure of a violation report generated by an accessibility checker consistent with an embodiment of the present invention.

FIG. 7 is an exemplary structure of a violation report generated by an accessibility checker consistent with an embodiment of the invention with a source code viewing window open.

FIG. 8 is an exemplary structure of an options menu of an accessibility checker consistent with an embodiment of the present invention allowing the user to determine the accessibility standards applied.

FIG. 9 is an exemplary structure of an options menu of an accessibility checker consistent with an embodiment of the present invention allowing the user to select the application in which the source code corresponding to any identified accessibility violation is displayed.

FIG. 10 is an exemplary structure of a violation report generated by an accessibility checker consistent with an embodiment of the present invention with the pull down menu open.

FIG. 11 is an exemplary structure of an options menu of an accessibility checker consistent with an embodiment of the present invention allowing the user to input access information regarding the application server and the proxy port to be used in the accessibility test.

FIG. 12 illustrates a computer system for implementing a software application consistent with an embodiment of the present invention.

FIG. 13 illustrates another computer system for implementing a software application consistent with an embodiment of the present invention.

### DETAILED DESCRIPTION

The following description refers to the accompanying drawings in which, in the absence of a contrary representation, the same numbers in different drawings represent similar elements. The implementations in the following description do not represent all implementations consistent with principles of the claimed invention. Instead, they are merely some examples of systems and methods consistent with those principles. It is to be understood that both the foregoing general description and the following detailed description are exemplary and explanatory only and are not restrictive of the invention as claimed.

As embodied herein, an accessibility checker is adapted to test the compliance of a web application with a predetermined set of accessibility guidelines. In order to ensure that information can be disseminated to a large number of people, websites and web applications are increasingly designed to offer information in alternative formats. For example, by providing a text description of an audio clip, an individual with a particular disability or sensory deprivation is able to access information that might not otherwise be available to him. Compliance with accessibility guidelines may also streamline the exchange of information, allowing a user to more quickly navigate a website. For instance, many websites require a user to enter information fields. Upon the user submitting information, the application may discover that a required field was not properly entered, and return the user to the information-gathering page with a red asterisk marking the required field. A colorblind user, however, may have difficulty picking the red asterisk out of the background. In such an instance, a text description of the missing field may help the user identify and complete the missing field more quickly.

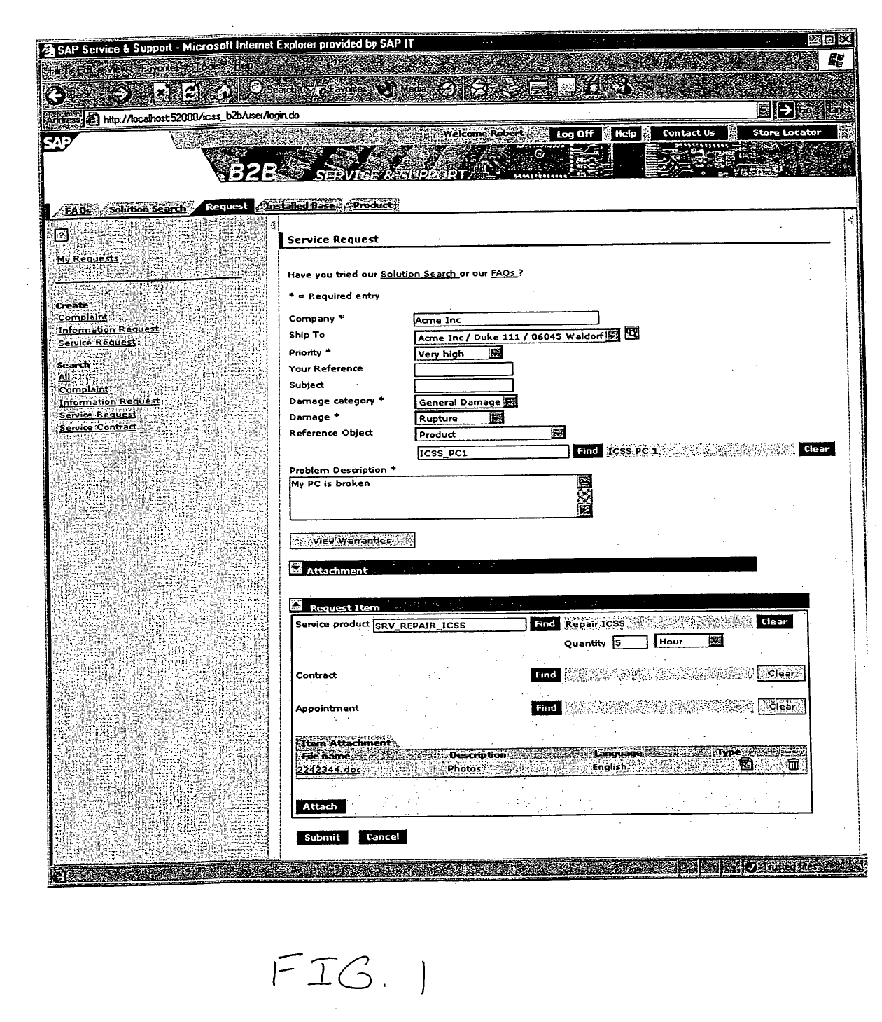

FIG. 1 provides an example of a transactional web page that may be checked for accessibility compliance with an accessibility checker consistent with the present invention. The transactional web page of FIG. 1 requests the user to enter information into a variety of fields, some of which are required and some that are not mandatory. The required fields are marked with an asterisk. An accessibility checker in accordance with the present invention may analyze the transaction and web page to determine whether the page complies with a selected set of accessibility rules to allow users with various disabilities or impediments to complete the transaction.

To assist application designers in ensuring that an application achieves the desired accessibility standard, an accessibility checker consistent with the present invention may be adapted to act as a proxy to intercept HTTP requests sent by a web browser to a web application server and to then intercept the HTTP responses returned from the application server to the web browser. The accessibility checker may be adapted to copy the HTTP responses from the application server before forwarding them to the web browser. The accessibility checker may be capable of checking the content of the HTTP response to determine whether an accessibility rule is violated. The accessibility checker may notify the user of identified violations of an accessibility rule. For example, the accessibility checker may be adapted to display detected violations in a graphical user interface. In one aspect, the accessibility checker may also identify the location in the HTTP source code that is responsible for any identified accessibility violation.

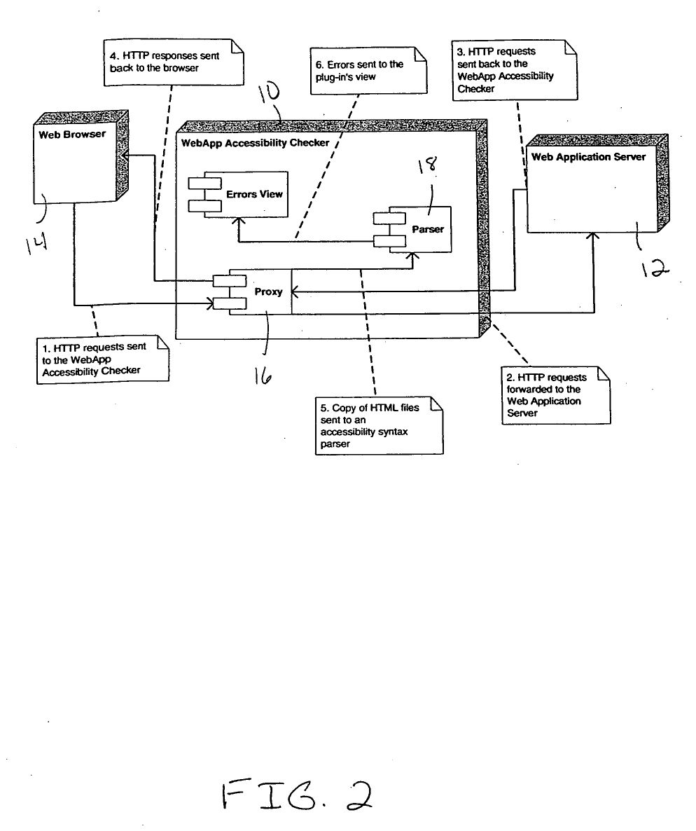

FIG. 2 is a flow diagram depicting the operation of an accessibility checker 10. A user testing the compliance of a web application server 12 may navigate server 12 using a web browser 14. Accessibility checker 10 may comprise a proxy execution thread 16 that intercepts HTTP requests sent from web browser 14 to application server 12 and forwards the HTTP requests to application server 12. Application server 12 may return the HTTP responses to proxy 16. Proxy 16 may be adapted to copy the HTTP responses before forwarding them from application server 12 to web browser 14.

Accessibility checker 10 may also comprise a parser 18. Proxy 16 may be adapted to send the copied HTTP responses received from application server 12 to parser 18. Parser 18 may be adapted to convert an HTTP response into a document object model (DOM) tree. Parser 18 may be adapted to analyze the HTTP response, or DOM tree, for compliance with a predetermined list of accessibility rules. In one version, parser 18 may be an extensible markup language (XML) parser, as available from open-source providers or from numerous vendors. Parser 18 may be adapted to analyze XML, well-formed HTML and XHTML documents. In one embodiment, parser 18 may be compliant with the W3C DOM specifications, available at http://www.w3.org/TR/2004/REC-DOM-Level-3-Core-20040407/ (last visited Feb. 2, 2005). Proxy thread 16, in one aspect, may be configured such that it copies and sends an HTTP response from application server 12 to parser 18 only if the response is a file-type that may be parsed and analyzed by parser 18.

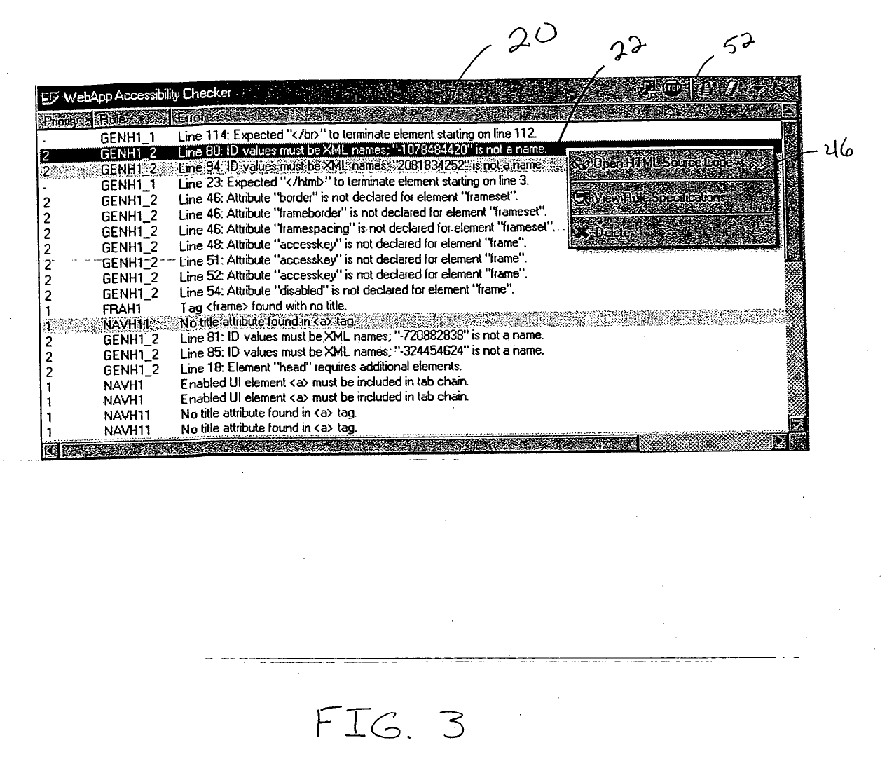

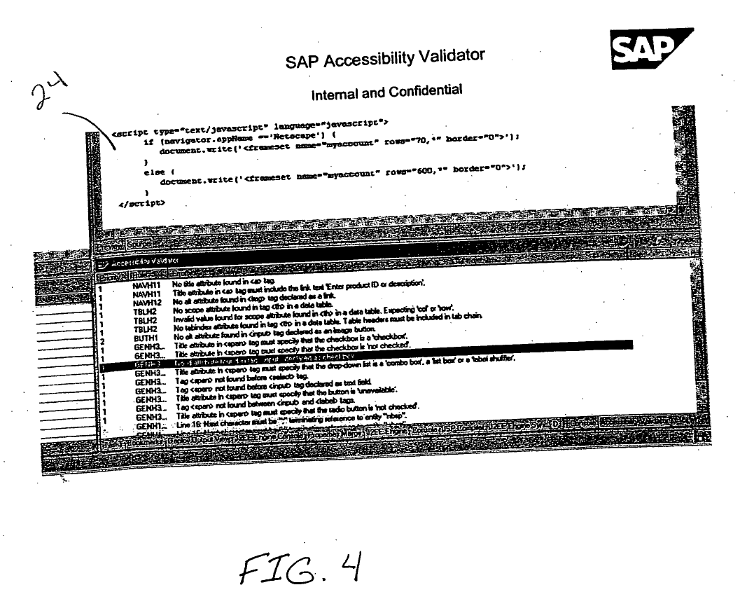

FIG. 3 shows an exemplary violation-viewing window 20 displaying a list of identified violations 22 of the applied accessibility rules detected in the HTTP response. Parser 18 may be adapted to compile the list of violations 22. Violation-viewing window 20 may be implemented as a thread that refreshes at discrete time intervals to check the violations identified by parser 18 and display any new violations 22. In one aspect, violation-viewing window 20 may refresh at one-second intervals. Accessibility checker 10 may also be operative to allow the user to select a particular identified violation 22 from violation-viewing window 20 and open the source code received from application server 12 to the portion that generated that violation. FIG. 4 shows an exemplary violation-viewing window 20 with a source code-viewing window 24 displaying the source code associated with a selected violation 22. It is recognized that violation-viewing window 20 is only one manner through which a developer may be notified of detected violations. An accessibility checker consistent with the principles of the present invention may notify the user of detected violations in various manners known in the art, including but not limited to a file dump, a shell, or audio notification.

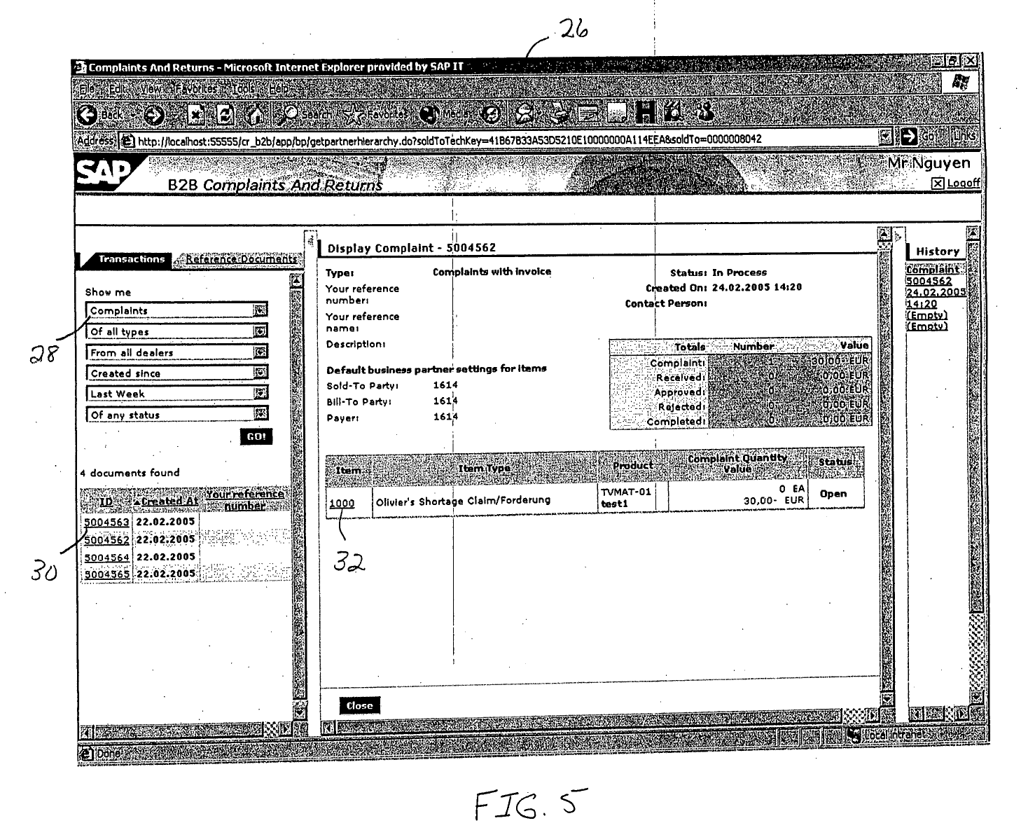

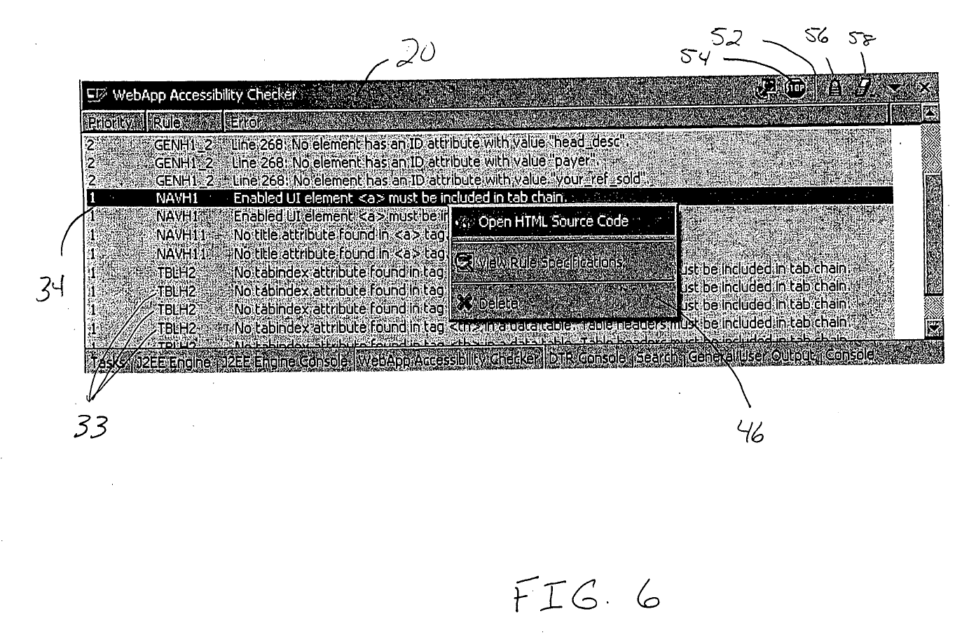

FIGS. 5 through 7 provide an example of the operation of accessibility checker 10. FIG. 5 shows web browser 14 encountering a web page 26 received from an application server 12. Web page 26 includes boxes 28 and links 30 that the user may engage to enter information or obtain further information from application server 12. In particular, web page 26 includes a link 32 titled “Item”. As the user navigates web page 26, accessibility checker 10 may be operative to parse and analyze the HTTP responses sent from server 12 to browser 14 against a list of accessibility rules. FIG. 6 depicts a list of violations 33 generated by accessibility checker 10's analysis of web page 26. In FIG. 6, an exemplary violation 34, titled “Enabled UI element <a> must be included in tab chain,” is shown. Violation 34 informs the user that link 32 is not included in the tab chain, meaning that the user may not be able to select link 32 by repeatedly engaging the TAB key on his keyboard to scroll through boxes 28 and links 30 contained on web page 26 until reaching link 32, thereby violating an accessibility rule applied in this example.

FIG. 7 shows violation-viewing window 20 with a source code-viewing window 24 open to the source code received from application server 12, with a portion 36 of the source code associated with violation 34 highlighted, thereby allowing the user to identify the responsible source code.

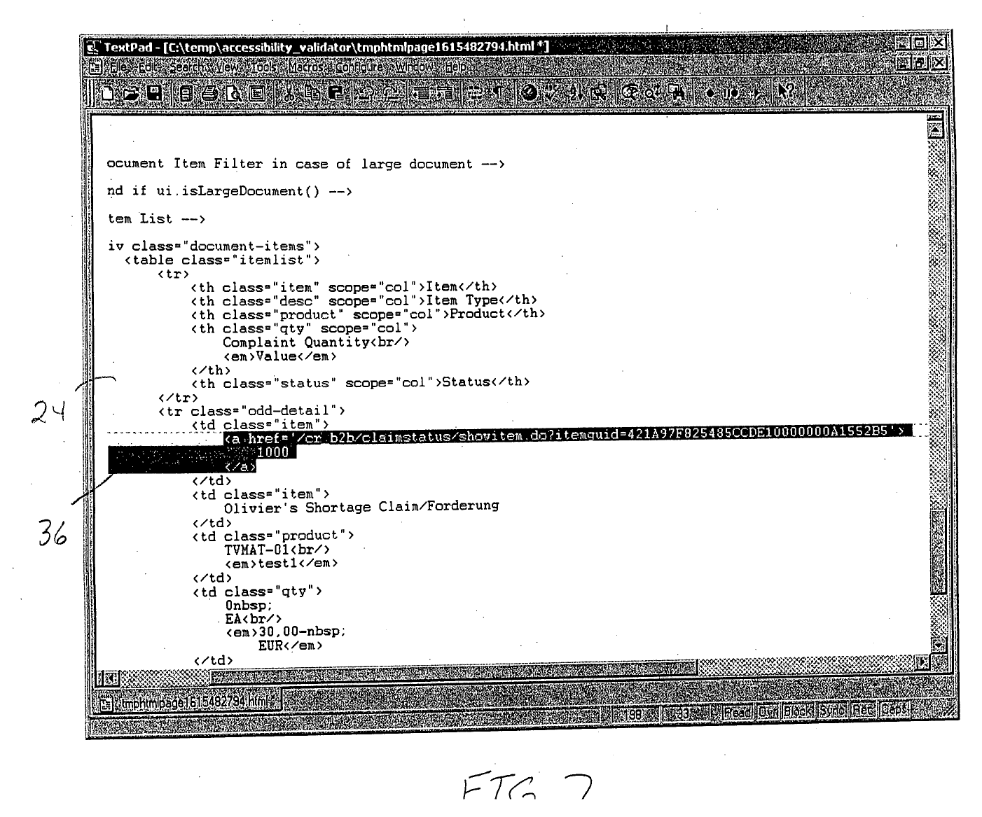

As mentioned above, accessibility checker 10 may be adapted to check an HTTP response from application server 12 against a set of predetermined accessibility rules. In one version, accessibility checker 10 may include a list of accessibility rules that the user can enable or disable at his choosing. FIG. 8 depicts an exemplary settings menu 38 open to an enabled rules window 40 of an accessibility checker 10. As pictured, enabled rules window 40 may comprise a list of rules 42, each of which may be associated with a check box 44. In this version, the user may disable a rule 42 by un-checking the associated check box 44 and activate a rule 42 by checking the associated box 44. However, it is recognized that there are many ways consistent with the present invention in which the accessibility checker 10 may allow the user to enable or disable a particular rule 42 or group of rules 42.

Accessibility checker 10 may be configured such that the user may take a number of actions in response to a violation 22 detected by parser 18 and displayed in violation-viewing window 20. In one aspect, the user may select a violation 22 to open a contextual menu 46 (FIG. 6) containing a list of actions available to the user.

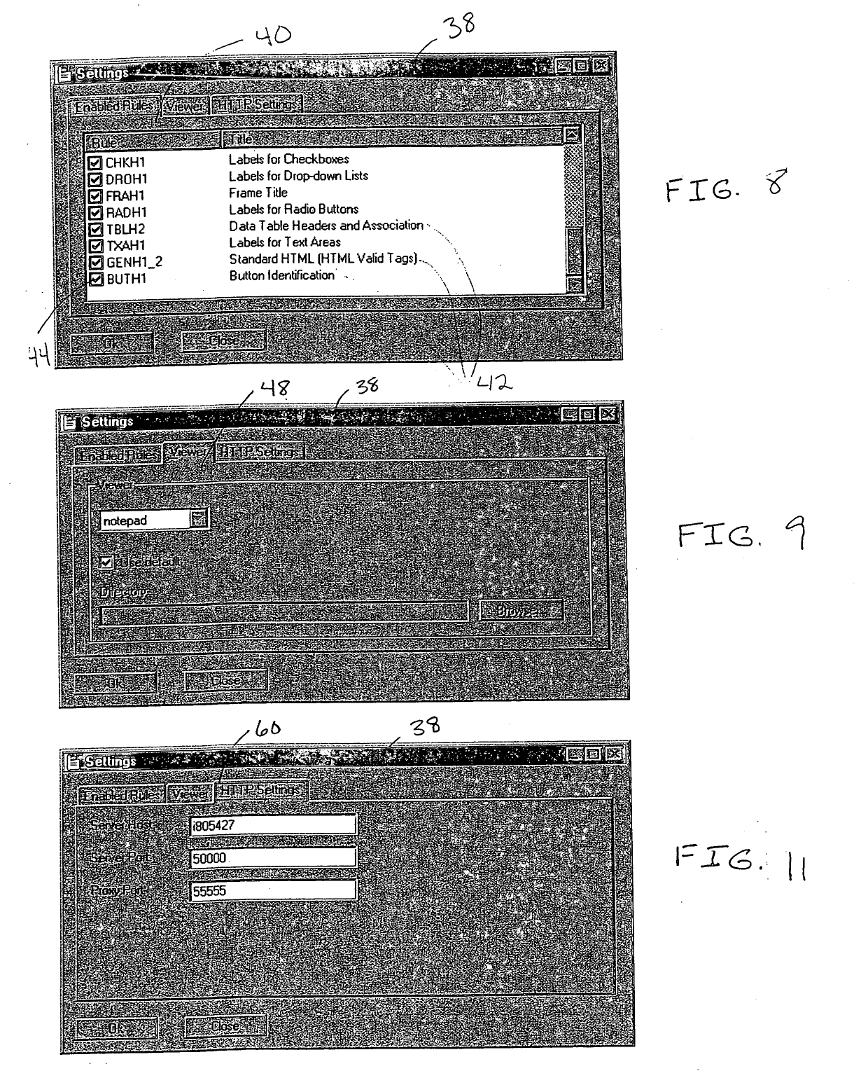

The user may use contextual menu 46 to access the document source code that generated accessibility violation 22. As illustrated in FIG. 9, settings menu 38 may include an output format selection window 48 that allows the user to select the format in which source code-viewing window 24 displays the error-generating source code, and may allow the user to select a particular application as the default setting.

Accessibility checker 10 may allow the user to view the particular accessibility rule 42 that was violated by the content of the parsed HTTP response. This option may be accessed via contextual menu 46, as shown in FIG. 3. Selecting the “view rule” option may link the user to a document or website containing the text of the violated accessibility rule 42. Similarly, accessibility checker 10 may allow the user to delete an identified violation 22 from the list assembled in violation-viewing window 20.

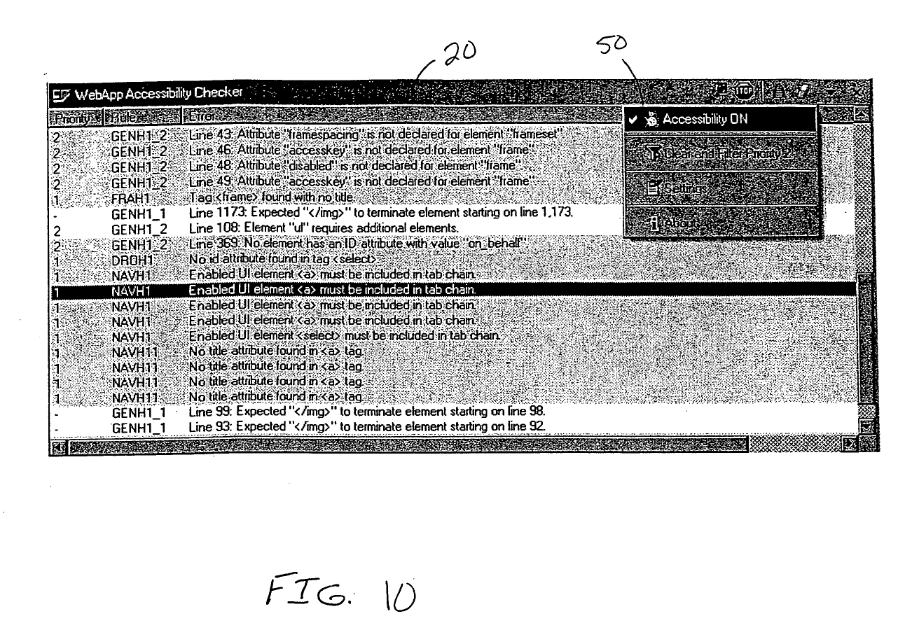

As illustrated in FIG. 10, accessibility checker 10 may comprise a pull down menu 50 reachable from graphical interface 20. Pull down menu 50 may include a variety of options allowing the user to customize operation of accessibility checker 10. As shown in FIG. 10, pull down menu 50 may allow the user to engage one or more of the following functions: (i) enable (or disable) the accessibility checker 10 to check HTTP requests against accessibility rules that apply both when the tested application is in an “accessible” mode and when it is not in the “accessible” mode; (ii) clear and filter a certain accessibility priority level; (iii) access the aforementioned settings menu 38; or (iv) access an “about” feature containing information about accessibility checker 10. In regard to the possible option to clear and filter a particular priority level, many accessibility standards comprise two or more levels of graduated accessibility. Typically, level one represents a minimum level of compliance, with higher levels representing greater degrees of accessibility. By allowing the user to clear and filter a certain priority level, the user is able to prevent accessibility checker 10 from returning a slew of violations 22 for an accessibility level he knows application 12 is unable to achieve.

Accessibility checker 10 may comprise a tool bar 52. In FIG. 6, tool bar 52 is shown in the top right-hand corner of graphical interface 20. However, that particular location of tool bar 52 is merely exemplary. Tool bar 52 may comprise various optional features of accessibility checker 10 that may be engaged by the user. For example, tool bar 52 may comprise a button 54 operative to start and stop the functioning of accessibility checker 10. As discussed in more detail below, accessibility checker 10 may be implemented in an application development environment. When implemented as a component of a development environment, accessibility checker 10 may be operative to instantiate whenever the development environment is opened. When instantiated, accessibility checker 10 utilizes certain system resources, such as a communication port, memory and CPU time. In certain instances, the developer may wish to work in the development environment without engaging accessibility checker 10. In order to free the system resources utilized by accessibility checker 10, it may be desirable to allow the developer to turn accessibility checker 10 on and off within the development environment.

Tool bar 52 may also comprise a scroll-locking feature 56. As mentioned above, in one embodiment, graphical interface 20 may periodically check the violation list compiled by parser 18 for newly identified violations 22, and may be adapted to display new violations 22 as they occur. In order to alert the user of new violations 22, graphical interface 20 may be adapted to jump to newly displayed violations 22. A scroll lock option allows the user to prevent graphical interface 20 from scrolling to newly identified violations 22. For the convenience of the developer, tool bar 52 may also comprise a button 58 operative to clear the list of identified violations 22 from graphical interface 20.

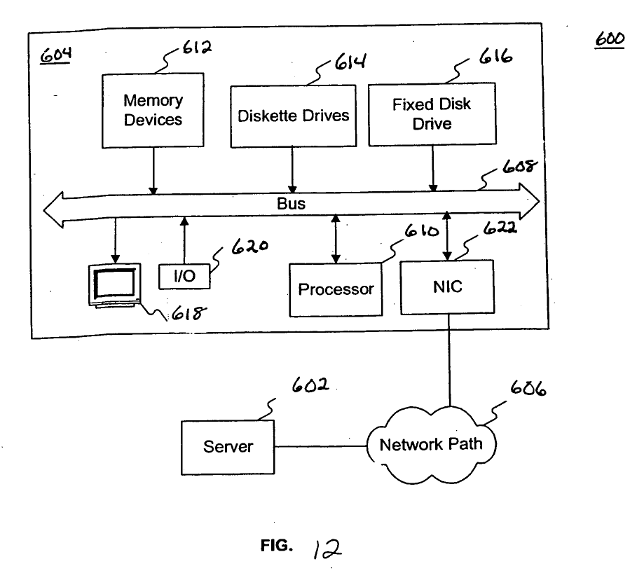

As described above, accessibility checker 10 may act as a proxy between web browser 14 and application server 12. To associate accessibility checker 10 with a particular application server 12 in order to test that application server, accessibility checker 10 may allow the user to enter the appropriate server host identification and server port, as well as the proxy port. In one version, as depicted in FIG. 11, settings menu 24 may include an HTTP Settings window 60 that allows the user to input such information.

Accessibility checker 10 may be a stand-alone application or may readily be incorporated into an application development environment, such as the SAP NetWeaver™ Developer Studio, available from SAP, AG, Walldorf, Germany. In this manner, accessibility checker 10 may be integrated with a package of application design tools in order to allow application designers to incorporate accessibility testing into the routine software development process. Accessibility checker 10 may also be configured as a plug-in or patch to complement an already-existing application developer environment. Accessibility checker 10 may be implemented in any operating system that provides a graphical user interface, such as Windows, Unix, Linux, or Apple's OS, but may also function in a non-graphical operating system or shell.

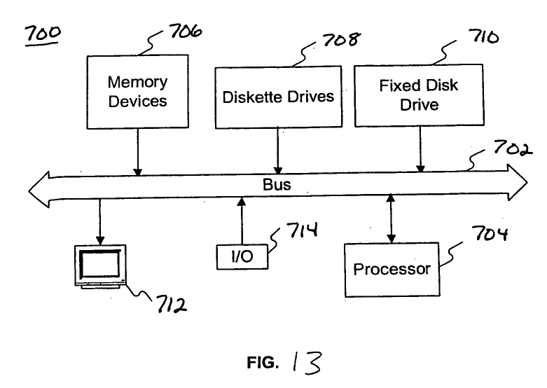

A computer system may be used to install a software application implementing a system and method for checking accessibility consistent with an embodiment of the present invention. The computer system may be a computer network, as shown in FIG. 12, or a stand-alone personal computer (PC), as shown in FIG. 13.

As shown in FIG. 12, a computer network 600 for implementing an accessibility checker consistent with the principles of the present invention may include a server 602 and a stand-alone PC 604 connected through a network path 606. Computer network 600 may be a local area network (LAN), where server 602 and PC 604 are workstations. Computer network 600 may also be the network, with server 602 hosting an application to be tested with the accessibility checker and PC 604 being any workstation available to an individual desiring to test the accessibility of an application. Alternatively, computer network 600 may be a wide area network (WAN), and server 602 and PC 604 may lie in two separate LANs connected through the network.

PC 604 may include a bus line 608 connecting a plurality of devices such as a processor 610, memory devices 612 for storage of information, diskette drives 614, a fixed disk drive 616, a monitor 618, other I/O devices 620, and a network interface card (NIC) 622. Processor 610 may be a microprocessor such as an Intel Pentium™ chip for processing applications. Memory devices 612 may include read-only memories (ROM) and/or random access memories (RAM). Diskette drives 614 may include a floppy drive and/or an optical disk (CD, DVD, etc.) drive. Fixed disk drive 616 may be a hard drive. I/O devices 620 may include a keyboard and/or a mouse for receiving input from a user of PC 604. Monitor 618 may display output from processor 610, and may also echo the input of the user. PC 604 may be connected to network path 606 through NIC 622.

An application to be tested for accessibility compliance may be installed on server 602. An individual desiring to test the accessibility of the application on server 602 may use a web browser loaded on PC 604, and may communicate with server 602 through NIC 622 and network path 606. In one aspect, the software application consistent with an embodiment of the present invention may be stored in PC 604 and processor 610 of PC 604 may execute the software application locally within PC 604 to test the accessibility of an application on server 602. Particularly, the software application may be stored on a floppy disk or an optical disk accessible by diskette drive 614 or on fixed disk drive 616 or on any other removable storage (external disk drive, USB flash memory, etc.) devices accessible by I/O devices 620. In another aspect, the software application consistent with an embodiment consistent with the present invention may be stored in server 602, which may execute the software application, and processor 610 of PC 604 may communicate with server 602 to send information to server 602 and retrieve the results of the execution of the software application from server 602.

Through the execution of the software application consistent with an embodiment of the present invention, either locally within PC 604 or remotely within server 602, the accessibility of a transactional application may be tested.

Alternatively, as shown in FIG. 13, a stand-alone PC 700 may be used for implementing a software application consistent with an embodiment of the present invention. PC 700 may include a bus line 702 connecting a plurality of devices, which may include a processor 704, memory devices 706 for storage of information, diskette drives 408, a fixed disk drive 710, a monitor 712, and other l/O devices 714. Processor 704 may be a microprocessor such as an Intel Pentium™ chip for processing applications. Memory devices 706 may include ROM and/or RAM. Diskette drives 708 may include a floppy drive and/or an optical disk (CD, DVD, etc.) drive. Fixed disk drive 710 may be a hard drive. Monitor 712 may display the output of processor 704 and may also echo the input of the user. I/O devices 714 may include a keyboard and/or a mouse for receiving input from a user of PC 700.

A software application consistent with an embodiment of the present invention for checking the accessibility of content and a transactional application to be tested may be stored together or separately on a floppy disk or an optical disk accessible by diskette drive 708 or on fixed disk drive 710 or on any other removable storage (external disk drive, USB flash memory, etc.) devices accessible by I/O devices 714. Processor 704 may execute the software application stored in the floppy disk, the optical disk accessible by diskette drive 708, or the fixed disk drive 710 or on any other removable storage (external disk drive, USB flash memory, etc.) devices accessible by I/O devices 714. An individual, through monitor 712 and I/O devices 714, may interact with processor 704, which may execute the software application, thereby checking the accessibility of a transactional application.

Accordingly, the disclosed system and method for checking accessibility can be used by a software designer to test the accessibility of transactional web applications. The accessibility checker can identify and display not only transactions that violate accessibility guidelines, but also the specific guidelines that are violated. Further, the accessibility checker can refer the designer to the application source code that generated the violation.

The foregoing description of possible implementations consistent with the present invention does not represent a comprehensive list of all such implementations or all variations of the implementations described. The description of only some implementation should not be construed as an intention to exclude other implementations. Artisans will understand how to implement the invention in the appended claims in many other ways, using equivalents and alternatives that do not depart from the scope of the following claims. Moreover, unless indicated to the contrary in the preceding description, none of the components described in the implementations is essential to the invention.

What is claimed is:

1. An accessibility checker for testing the accessibility of an HTTP response sent from an application server to a web browser comprising:
(i) a proxy adapted to receive an HTTP request from the web browser and forward the HTTP request to the application server, wherein the proxy thread is further adapted to receive the HTTP response from the application server;
(ii) a parser adapted to receive a copy of the HTTP response from the proxy thread, wherein the parser is adapted to parse and analyze the HTTP response to identify a violation of an accessibility rule;
and
(iii) an interface adapted to notify a user of an identified violation received from the parser.

2. The accessibility checker of claim 1, wherein the proxy is adapted to forward the HTTP response to the web browser as well as to the parser.

3. The accessibility checker of claim 1, wherein the interface is adapted to display a portion of source code of the HTTP response responsible for generating the identified violation.

4. The accessibility checker of claim 3, further adapted to allow a user to select the format in which the source code is displayed.

5. The accessibility checker of claim 1, wherein the interface is adapted to display the source code responsible for generating an identified violation in response to selection of the identified violation by a user.

6. The accessibility checker of claim 1, further providing a link to the text of the accessibility rule violated by the identified violation.

7. The accessibility checker of claim 1, wherein the interface is adapted to check the parser for the identified violation at predetermined time intervals.

8. The accessibility checker of claim 1, wherein the interface is notified of the identified violation by an event-driven mechanism.

9. The accessibility checker of claim 1, wherein the parser is an extensible markup language parser and is adapted to parse the HTTP response into a document object model tree.

10. The accessibility checker of claim 9, wherein the proxy is adapted to send the HTTP response to the parser only if the response may be parsed and analyzed by an extensible markup language parser.

11. The accessibility checker of claim 1, wherein the accessibility rule to be applied is selected by a user.

12. The accessibility checker of claim 1, wherein the accessibility checker is integrated into a web application developer environment.

13. The accessibility checker of claim 1, being further adapted to receive server address and port information for the application server and port information for the proxy thread from a user.

14. A method for checking the accessibility of an HTTP response sent from an application server to a web browser comprising:
(i) intercepting an HTTP request sent from the web browser and forwarding the HTTP request to the application server;
(ii) intercepting the HTTP response from the application server;
(iii) parsing and analyzing the HTTP response for a violation of an accessibility rule; and
(iv) returning an identified violation of the accessibility rule to a user.

15. The method of claim 14, further comprising displaying the identified violation in a graphical interface.

16. The method of claim 15, further comprising displaying the source code of the HTTP response responsible for generating the identified violation in response to selection of that violation by a user.

17. The method of claim 14, further comprising linking the user to the accessibility rule associated with the identified violation in response to selection of the violation by a user.

18. The method of claim 14, further comprising parsing the HTTP response into a document object model tree.

19. The method of claim 18, further comprising choosing the accessibility rule to be applied from a predetermined list of rules.

20. A computer readable medium comprising instructions, the execution of which causes a computer to perform stages comprising:
(i) intercepting a file sent from an application server to a web browser;
(ii) parsing and analyzing the file for a violation of an accessibility rule;
and
(iii) notifying the user of an identified violation of the accessibility rule.
